(19) United States
(12) Patent Application Publication
(10) Pub. No.: US 2026/0039245 A1
(43) Pub. Date: Feb. 5, 2026

(54) METHOD AND APPARATUS FOR DETECTING FAILURE OF SOLAR MODULE

(71) Applicant: HANWHA SOLUTIONS CORPORATION, Seoul (KR)

(72) Inventors: Kyoung Mo KOO, Seoul (KR); Su Chang LEE, Seoul (KR); Mi So KIM, Seoul (KR)

(73) Assignee: HANWHA SOLUTIONS CORPORATION, Seoul (KR)

(21) Appl. No.: 19/276,278

(22) Filed: Jul. 22, 2025

(30) Foreign Application Priority Data
Aug. 2, 2024 (KR) 10-2024-0103086

(51) Int. Cl. H02S 50/00

(52) U.S. Cl. CPC H02S 50/00

(57) ABSTRACT

Provided are a method and apparatus for detecting a failure of a solar module. The method includes obtaining real-time power generation data of each of a plurality of solar modules included in at least one solar array, setting a reference value using at least one of past power generation data of the plurality of solar modules and specifications of the plurality of solar modules, determining each of the plurality of solar modules to be either a normal solar module or an abnormal solar module by comparing the reference value with a power generation amount of each of the plurality of solar modules, which is calculated using the real-time power generation data, and providing an interface displaying a solar module determined to be the abnormal solar module.

### CROSS-REFERENCE TO RELATED APPLICATION

This application is based on and claims priority under 35 U.S.C. § 119 to Korean Patent Application No. 10-2024-0103086, filed on, Aug. 2, 2024, in the Korean Intellectual Property Office, the disclosure of which is incorporated by reference herein in its entirety.

### BACKGROUND

### 1. Field

The present disclosure relates to a method and apparatus for detecting a failure of a solar module.

### 2. Description of the Related Art

Solar power generation is a power generation technology that may produce electricity with almost no pollution by directly collecting energy from the sun and converting it into electricity. Therefore, solar power generation is a sustainable energy source that is rapidly growing and is receiving attention as an eco-friendly power source.

Most electricity production involves burning fossil fuels, which emit greenhouse gases and other air pollutants, a major cause of climate change and air pollution. Therefore, consumption culture that uses electricity efficiently and consumption of electric energy through self-generation, such as solar power generation, may provide many benefits to the environment, economy, and society.

However, because solar modules are installed outdoors and susceptible to various environmental factors, solar modules are prone to failure. Accordingly, there is a need for technology that may quickly detect faulty solar modules and provide notifications for maintenance.

Information disclosed in this Background section was already known to the inventors of the present invention before achieving the present invention or is technical information acquired in the process of achieving the present invention. Therefore, it may contain information that does not form the prior art that is already known to the public in this country.

### SUMMARY

The present disclosure provides a method and apparatus for detecting a failure of a solar module. The problems to be solved by the present disclosure are not limited to the problems mentioned above, and other problems and advantages of the present disclosure that are not mentioned may be understood by the following description and will be more clearly understood through the embodiments of the present disclosure. In addition, it will be appreciated that the problems and advantages to be solved by the present disclosure may be realized by the means defined in the appended claims and combinations of the means.

As a technical means for achieving the above-described technical task, a first aspect of the present disclosure provides a method of detecting a failure of a solar module. The method includes obtaining real-time power generation data of each of a plurality of solar modules included in at least one solar array, setting a reference value using at least one of past power generation data of the plurality of solar modules and specifications of the plurality of solar modules, determining each of the plurality of solar modules to be either a normal solar module or an abnormal solar module by comparing the reference value with a power generation amount of each of the plurality of solar modules, which is calculated using the real-time power generation data, and providing an interface displaying a solar module determined to be the abnormal solar module.

A second aspect of the present disclosure provides an apparatus for detecting a failure of a solar module. The apparatus includes a memory storing at least one program and a processor configured to perform an operation by executing the at least one program, wherein the processor is further configured to obtain real-time power generation data of each of a plurality of solar modules included in at least one solar array, set a reference value using at least one of past power generation data of the plurality of solar modules and specifications of the plurality of solar modules, determine each of the plurality of solar modules to be either a normal solar module or an abnormal solar module by comparing the reference value with a power generation amount of each of the plurality of solar modules, which is calculated using the real-time power generation data, and provide an interface displaying a solar module determined to be the abnormal solar module.

A third aspect of the present disclosure provides a computer-readable recording medium having recorded thereon a program for executing the method of the first aspect on a computer.

In addition, other methods and systems for implementing the present disclosure and computer-readable recording media storing a computer program for executing the other methods may be further provided.

Other aspects, features, and advantages than those described above will become apparent from the following drawings, claims, and detailed description.

### BRIEF DESCRIPTION OF THE DRAWINGS

These and other aspects, features, and advantages of certain embodiments of the disclosure will be more apparent from the following description taken in conjunction with the accompanying drawings in which:

FIG. 1 is a conceptual diagram illustrating a method of detecting a failure of a solar module, according to an embodiment;

FIG. 2 is a block diagram of a user terminal according to an embodiment;

FIG. 3 is a block diagram of a system including a user terminal and an external device, according to an embodiment;

FIG. 4 is a flowchart of a method of detecting a failure of a solar module, according to an embodiment;

FIG. 5 is a diagram illustrating a method of determining an abnormal solar module based on cumulative power generation data, according to an embodiment;

FIG. 6 is a diagram illustrating a method of determining an abnormal solar module based on rated power generation data, according to an embodiment;

FIG. 7 is a diagram illustrating an interface that displays an abnormal solar module, according to an embodiment;

FIG. 8 is a diagram illustrating an interface that displays a notification for maintenance of a solar module, according to an embodiment; and

FIG. 9 is a diagram illustrating an interface that displays a notification of an error code, according to an embodiment.

### DETAILED DESCRIPTION

The advantages and features of the present disclosure and methods of achieving them will become apparent by reference to the embodiments described in detail together with the accompanying drawings. However, the present disclosure is not limited to the embodiments presented below but may be implemented in various forms and should be understood to include all transformations, equivalents, or substitutes included in the spirit and technical scope of the present disclosure. Rather, these embodiments are provided so that this disclosure will be thorough and complete, and will fully convey the scope of the invention to one of ordinary skill in the art. In the description of the present disclosure, certain detailed explanations of the related art are omitted when it is deemed that they may unnecessarily obscure the essence of the present invention.

The terminology used herein is merely used to describe particular embodiments and is not intended to limit the present disclosure. Singular expressions include plural expressions unless the context clearly indicates otherwise. Furthermore, it is to be understood that the terms such as “including,” “having,” and “comprising” are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Some embodiments of the present disclosure may be represented by functional block configurations and various processing operations. Some or all of these functional blocks may be implemented using any number of hardware and/or software components that perform specific functions. For example, the functional blocks of the present disclosure may be implemented using one or more microprocessors or circuits for a given function. Also, for example, the functional blocks of the present disclosure may be implemented in various programming or scripting languages. The functional blocks may be implemented with algorithms running on one or more processors. The present disclosure may also employ conventional techniques for electronic configuration, signal processing, and/or data processing. The terms “mechanism,” “element,” “means,” and “configuration” may be used in a broad sense and are not limited to mechanical and physical configurations.

Furthermore, the connecting lines or connecting members between the components depicted in the drawings are intended to represent exemplary functional relationships and/or physical or logical connections between the components. In a practical device, many alternative or additional functional, physical, or logical connections between components may be presented.

The present disclosure will be described in detail with reference to the accompanying drawings.

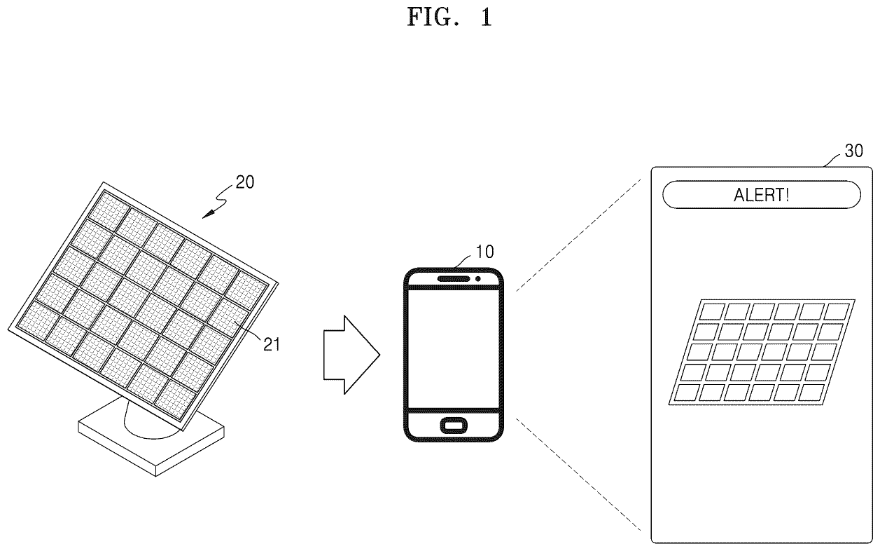

FIG. 1 is a conceptual diagram illustrating a method of detecting a failure of a solar module, according to an embodiment.

Referring to FIG. 1, a user terminal 10 may include a smartphone, a smart pad, and/or a tablet personal computer (PC). The user terminal 10 may include a personal computer such as a desktop or laptop. The user terminal 10 may include, but not limited to, a smart accessory, such as a smartwatch and/or a head-mounted device (HMD).

A solar array 20 may refer to a device that connects a plurality of solar modules 21 in series or parallel to each other and converts solar energy into electrical energy. For example, the solar array 20 may include a microinverter that converts direct current power, which is produced from the solar modules 21, into alternating current power.

Each of the solar modules 21 may refer to a device that connects a plurality of solar cells in series or parallel to each other and converts solar energy into electrical energy.

The user terminal 10 may obtain real-time power generation data of at least one solar array 20 and/or the solar modules 21. Here, the real-time power generation data may include, but not limited to, data on the power generation amount of at least one solar array 20 and/or the solar modules 21 and, in the case of the solar array 20 equipped with a microinverter, data on the frequency of power that has been converted from direct current to alternating current.

The user terminal 10 may calculate the power generation amount of each of the solar modules 21 based on real-time power generation data of at least one solar array 20 and/or the solar modules 21. For example, the user terminal 10 may calculate the amount of electricity generated by each of the solar modules 21 for a certain time period.

The user terminal 10 may set a reference value for determining a normal solar module and an abnormal solar module by using at least one of past power generation data of the solar modules 21 and a preset specification for each of the solar modules 21.

Here, a normal solar module may refer to a solar module that has no problems in producing electricity. An abnormal solar module may refer to a solar module that has failed to produce electricity. For example, failures that may occur in an abnormal solar module may include, but not limited to, a failure due to a surface defect, a failure due to poor installation, and a failure due to a defective module. A failure due to a surface defect may occur when foreign substances adhere to the surface of a solar module 21 and power may not be generated normally. A failure due to poor installation may occur when a connector of a cable connecting solar modules 21 to each other or a connector of a cable connecting the solar array 20 to a load is not properly connected. A failure due to a defective module may occur when damage occurs to a pin inside the connector.

The reference value may include, but not limited to, a reference power generation amount or a reference frequency.

For example, the user terminal 10 may use past power generation data to set the average power generation amount of the plurality of solar modules 21 as the reference power generation amount. Specifically, the user terminal 10 may divide the total amount of power generated by the solar modules 21 for a certain time period in past power generation data by the number of solar modules 21 included in the solar array 20 and may set the average amount of power generation as the reference power generation amount.

The user terminal 10 may set, as the reference power generation amount, rated power generation data preset for each of the solar modules 21.

The user terminal 10 may set the reference frequency based on at least one load included in a solar power generation system. Here, the reference frequency may be set according to the specifications or established certification regulations of the load.

The user terminal 10 may determine each of the solar modules 21 to be either a normal solar module or an abnormal solar module by comparing the reference value with the power generation amount of each of the solar modules 21, which is calculated using real-time power generation data.

The user terminal 10 may provide an interface 30 that displays a solar module determined to be an abnormal solar module.

Specifically, the user terminal 10 may generate the interface 30 that displays a normal solar module and an abnormal solar module different from each other by at least one of hue, saturation, and brightness. Through this, a user may efficiently recognize a faulty solar module, unlike the interface 30 that displays the power generation amount of each solar module by changing only one of saturation and brightness.

The user terminal 10 may provide a user with a notification for maintenance of an abnormal solar module. This allows a user to immediately recognize a faulty solar module and take quick action to avoid any problems with future power production.

The user terminal 10 may also provide an error code including information about trouble that has occurred in a solar module 21 along with the notification for maintenance so that the user may efficiently recognize the trouble.

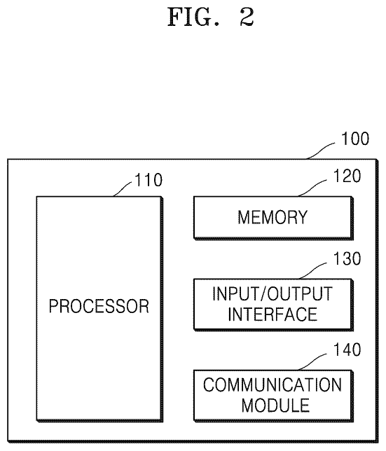

FIG. 2 is a block diagram of a user terminal according to an embodiment.

Referring to FIG. 2, a user terminal 100 may include a processor 110, a memory 120, an input/output interface 130, and a communication module 140. For convenience of description, only components related to the present disclosure are illustrated in FIG. 2. Accordingly, in addition to the components illustrated in FIG. 2, other general-purpose components may be further included in the user terminal 100. In addition, it is obvious to one of ordinary skill in the art related to the present disclosure that the processor 110, the memory 120, the input/output interface 130, and the communication module 140 in FIG. 2 may be implemented as independent devices.

The processor 110 may process a command of a computer program by performing basic arithmetic, logic, and input/output operations. Here, the command may be provided from the memory 120 or an external device. The processor 110 may generally control operations of other components included in the user terminal 100.

For example, the processor 110 may calculate a power generation amount of each of a plurality of solar modules included in at least one solar array, based on real-time power generation data of each of the solar modules. The processor 110 may set a reference value by using at least one of past power generation data of the solar modules and specifications of the solar modules.

The processor 110 may determine an abnormal solar module among the solar modules by comparing the reference value with the power generation amount of each of the solar modules.

For example, the processor 110 may use big data technology to determine an abnormal solar module. Specifically, the processor 110 may collect and analyze past power generation data of solar modules. For example, the processor 110 may be used to set a reference value based on past power generation data of a solar module that has experienced a failure in the past.

The processor 110 may be implemented as an array of a plurality of logic gates or as a combination of a general-purpose microprocessor and a memory storing a program that may be executed on the microprocessor. For example, the processor 110 may include a general-purpose processor, a central processing unit (CPU), a microprocessor, a digital signal processor (DSP), a controller, a microcontroller, a state machine, or the like. In some environments, the processor 110 may include an application-specific integrated circuit (ASIC), a programmable logic device (PLD), a field programmable gate array (FPGA), or the like. For example, the processor 110 may refer to a combination of processing devices, such as a combination of a DSP and a microprocessor, a combination of a plurality of microprocessors, a combination of one or more microprocessors in combination with a DSP core, or a combination of any other such components.

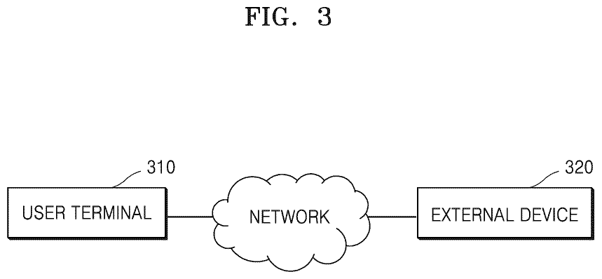

The memory 120 may include any non-transitory computer-readable recording medium. For example, the memory 120 may include a permanent mass storage device, such as random access memory (RAM), read-only memory (ROM), a disk drive, a solid-state drive (SSD), or flash memory. For example, a permanent mass storage device, such as ROM, SSD, flash memory, or a disk drive, may be separate from the memory 120. The memory 120 may store an operating system (OS) and at least one piece of program code (e.g., code for the processor 110 to perform an operation described below with reference to FIGS. 3 to 9).

These software components may be loaded from a computer-readable recording medium that is separate from the memory 120. The computer-readable recording medium may be directly connected to the user terminal 100 and may include an input/output computer-readable recording medium, such as a floppy drive, a disk, tape, a digital versatile disk (DVD)/compact disk (CD)-ROM drive, or a memory card. Alternatively, the software components may be loaded to the memory 120 via the communication module 140 rather than the computer-readable recording medium. For example, at least one program may be loaded to the memory 120, based on a computer program (e.g., a computer program for the processor 110 to perform an operation described below with reference to FIGS. 3 to 9), which is installed by files that a developer or a file distribution system distributing installation files of an application provides via the communication module 140.

The input/output interface 130 may be a means for interfacing with an input and/or output device (e.g., a keyboard, mouse, etc.), which may be connected to or included in the user terminal 100. In FIG. 2, the input/output interface 130 is depicted as a component configured separately from the processor 110 but is not limited thereto. The input/output interface 130 may be configured to be included in the processor 110.

The communication module 140 may provide a configuration or function for allowing the user terminal 100 to communicate with an external device (not shown) via a network. The communication module 140 may also provide a configuration or function for allowing the user terminal 100 to communicate with another external device. For example, a control signal, a command, data, or the like provided under control by the processor 110 may be transmitted to an external device via the communication module 140 and a network.

Although not shown in FIG. 2, the user terminal 100 may include a display module. For example, the user terminal 100 may display, through a display module, an interface indicating an abnormal solar module among a plurality of solar modules.

FIG. 3 is a block diagram of a system including a user terminal and an external device, according to an embodiment.

Referring to FIG. 3, a user terminal 310 may include any type of server that manages a web and/or an app capable of providing artificial intelligence services. The user terminal 310 in FIG. 3 may be the same device as the user terminal 10 in FIG. 1 and/or the user terminal 100 of FIG. 2.

An external device 320 may refer to an entity that provides information for the user terminal 310 to determine an abnormal solar module. The external device 320 may include any type of server that manages various types of information. The external device 320 may include, but not limited to, a database and a server that manages a web service application programming interface (API) which may provide information. The external device 320 may also include a hardware device (e.g., an edge computing device or a cloud computing device), which generates data on its own, in addition to the server.

For example, the external device 320 may correspond to a database that stores past power generation data of a plurality of solar modules included in at least one solar array.

The user terminal 310 and the external device 320 may communicate with each other and/or with other devices through a network. The network may refer to a comprehensive data communication network that allows different entities to smoothly communicate with each other and may include wired Internet, wireless Internet, and a mobile wireless communication network. For example, the network may include a local area network (LAN), a wide area network (WAN), a value added network (VAN), a mobile radio communication network, a satellite communication network, and a combination thereof. For example, wireless communication may include, but not limited to, wireless fidelity (Wi-Fi) communication, Bluetooth communication, Bluetooth low energy (BLE) communication, ZigBee communication, Wi-Fi direct (WFD) communication, ultrawideband (UWB) communication, infrared data association (IrDA) communication, and near field communication (NFC).

The user terminal 310 may communicate with the external device 320 through a network. The user terminal 310 may receive data from the external device 320 by communicating with the external device 320 through the network and provide a response based on the received data.

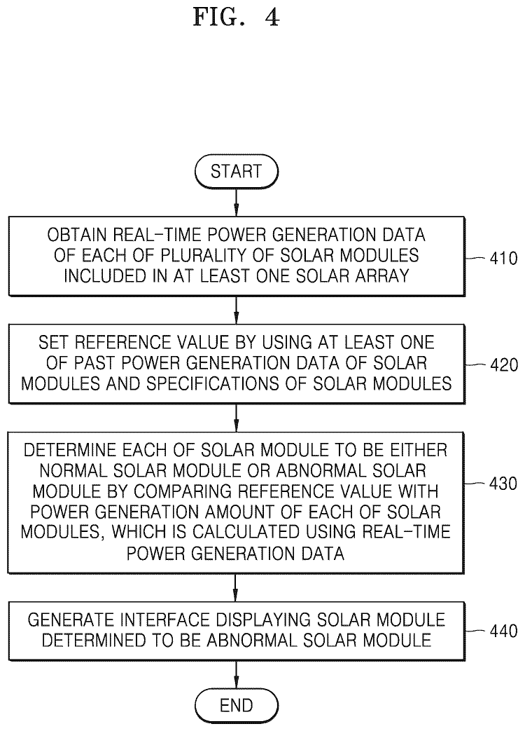

FIG. 4 is a flowchart of a method of detecting a failure of a solar module, according to an embodiment.

Referring to FIG. 4, the method of detecting a failure of a solar module may include operations performed time-sequentially by the user terminal 100 and/or the processor 110 in FIG. 2. Accordingly, even through descriptions are omitted below, the descriptions given above with respect to the user terminal 100 or the processor 110 in FIG. 2 may also be applied to the method of FIG. 4.

The processor 110 may obtain real-time power generation data of each of a plurality of solar modules included in at least one solar array in operation 410.

Here, the power generation data may include, but not limited to, data on the power generation amount of at least one solar array and/or a plurality of solar modules and, in the case of a solar array equipped with a microinverter, data on the frequency of power that has been converted from direct current to alternating current.

The processor 110 may set a reference value by using at least one of past power generation data of the solar modules and specifications of the solar modules in operation 420.

In an embodiment, the processor 110 may set the reference value based on the amount of power generated by each of the solar modules for a certain time period. Specifically, the processor 110 may calculate the average power generation amount of the solar modules by dividing the amount of power generated by the solar array for the certain time period by the number of solar modules included in the solar array. The processor 110 may set the average power generation amount as a reference power generation amount.

In some embodiments, the processor 110 may set the reference value based on rated power generation data of the solar modules. Specifically, the processor 110 may set the rated power generation data determined according to the specifications of a solar module as the reference power generation amount. Here, the rated power generation data may refer to a power generation amount that a solar module is set to produce for the certain time period.

In some embodiments, the processor 110 may set a reference frequency based on at least one load included in a solar power generation system. Specifically, the processor 110 may set a preset rated frequency as the reference frequency according to the location and type of the load.

The processor 110 may determine each of the solar modules to be either a normal solar module or an abnormal solar module by comparing the reference value with the power generation amount of each of the solar modules, which is calculated using real-time power generation data, in operation 430.

In an embodiment, the processor 110 may calculate the power generation amount of each of the solar modules for the certain time period by using the real-time power generation data. The processor 110 may determine each of the solar modules to be either a normal solar module or an abnormal solar module by comparing the power generation amount of each of the solar modules for the certain time period, which is calculated using the real-time power generation data, with the average power generation amount of the solar modules for the certain time period.

Specifically, the processor 110 may determine a solar module, which has a power generation amount that falls below a certain range based on the average power generation amount, as an abnormal solar module.

In some embodiments, the processor 110 may calculate the power generation amount of each of the solar modules for the certain time period by using the real-time power generation data The processor 110 may determine each of the solar modules to be either a normal solar module or an abnormal solar module by comparing the power generation amount of each of the solar modules for a certain time period, which is calculated using the real-time power generation data, with a preset rated power generation amount of each of the solar modules.

Specifically, the processor 110 may determine a solar module, which has a power generation amount that falls below a certain range based on the rated power generation amount, as an abnormal solar module.

In some embodiments, when a solar module includes a microinverter, the processor 110 may calculate the frequency of power that has been converted from direct current to alternating current. The processor 110 may determine each of the solar modules to be either a normal solar module or an abnormal solar module by comparing the calculated frequency of the power with the reference frequency.

Specifically, the processor 110 may determine a solar module, which has a frequency that falls below a certain range based on the reference frequency, as an abnormal solar module.

The processor 110 may generate an interface that displays a solar module determined to be an abnormal solar module in operation 440.

For example, the processor 110 may generate an interface that displays normal and abnormal solar modules differently from each other by at least one of hue, saturation, and brightness.

The processor 110 may generate an interface that additionally displays power data of all solar modules included in the solar array. For example, the processor 110 may generate an interface that displays the amount of power generated by each solar module per hour.

The processor 110 may also generate a notification for maintenance of an abnormal solar module. Here, the notification may include an error code indicating information about the cause of a failure of the solar module.

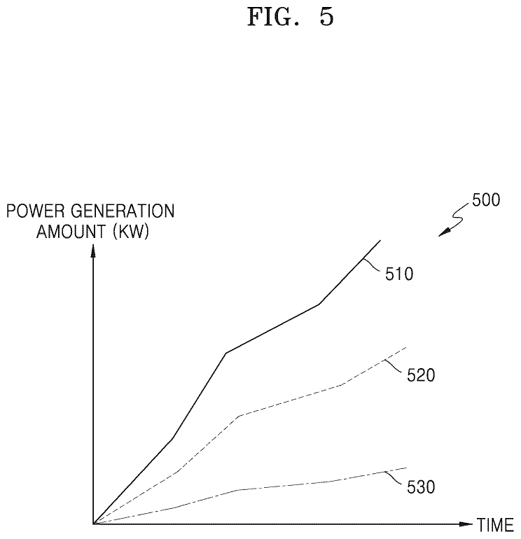

FIG. 5 is a diagram illustrating a method of determining an abnormal solar module based on cumulative power generation data, according to an embodiment.

Referring to FIG. 5, a graph 500 represents a cumulative power generation amount over time. In the graph 500, the X-axis represents time, and the Y-axis represents cumulative power generation amount.

A first line 510 represents a cumulative power generation amount of a solar array over time. A second line 520 represents a cumulative power generation amount of a first solar module included in the solar array over time. A third line 530 represents a cumulative power generation amount of a second solar module included in the solar array over time.

The user terminal 100 may calculate the average power generation amount of a plurality of solar modules for a first time period, based on the value of the first line 510. For example, the user terminal 100 may calculate the cumulative amount of power produced by the solar array for the first time period by using the first line 510. The user terminal 100 may calculate the average power generation amount by dividing the cumulative power generation amount by the number of solar modules included in the solar array. The user terminal 100 may set the average power generation amount as a reference value.

The user terminal 100 may calculate the cumulative amount of power produced by the first solar module for the first time period, based on real-time power generation data, through the second line 520. The user terminal 100 may also calculate the cumulative amount of power produced by the second solar module for the first time period, based on the real-time power generation data, through the third line 530.

The user terminal 100 may determine each solar module to be either a normal solar module or an abnormal solar module by comparing the average power generation amount with the cumulative power generation amount of each solar module for the first time period.

Specifically, the user terminal 100 may set a certain range based on the average power generation amount. For example, the certain range may be from 90% to 110% of the average power generation amount. The user terminal 100 may determine a solar module, of which the cumulative power generation amount for the first time period does not fall within the certain range, as an abnormal solar module.

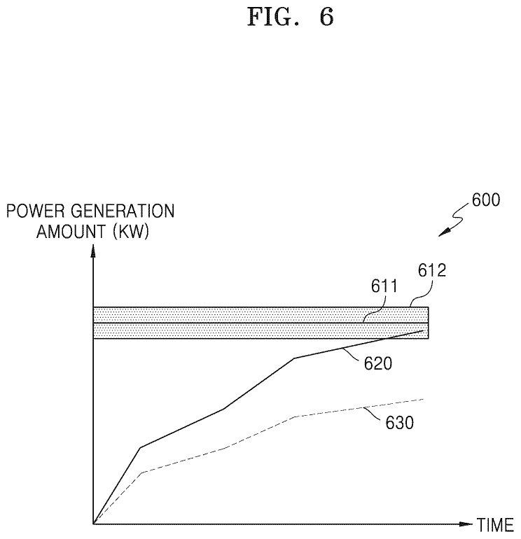

FIG. 6 is a diagram illustrating a method of determining an abnormal solar module based on rated power generation data, according to an embodiment.

Referring to FIG. 6, a graph 600 represents a cumulative power generation amount over time. In the graph 600, the X-axis represents time, and the Y-axis represents cumulative power generation amount.

A first line 611 represents a rated power generation amount preset according to the specification of a solar module included in a solar array. A first region 612 represents a certain range set based on the rated power generation amount. A second line 620 represents a cumulative power generation amount of a first solar module included in the solar array over time. A third line 630 represents a cumulative power generation amount of a second solar module included in the solar array over time.

The user terminal 100 may set the preset rated power generation amount as a reference value according to the specification of a solar module. Here, the rated power generation amount may refer to the amount of power that a solar module is set to produce for a certain time period.

The user terminal 100 may calculate the cumulative amount of power produced by the first solar module for the certain time period, based on real-time power generation data, through the second line 620. The user terminal 100 may calculate a cumulative amount of power produced by the second solar power module for the certain time period, based on the real-time power generation data, through the third line 630. Here, the certain time period may be the same as the certain time period used to calculate the rated power generation amount.

The user terminal 100 may determine the solar module to be either a normal solar module or an abnormal solar module by comparing the rated power generation amount with the cumulative power generation amount of each solar module for the certain time period.

Specifically, the user terminal 100 may set a certain range based on the rated power generation amount of the solar module included in the solar array. For example, when the rated power generation amount of the solar module is 349 W, the user terminal 100 may set a certain range of 341 W to 365 W, which corresponds to 95% to 105% of the rated power generation amount. The user terminal 100 may determine a solar module, of which the cumulative power generation amount for the certain time period does not fall within the certain range, as an abnormal solar module.

In some embodiments, the user terminal 100 may additionally use the ratio of the number of solar modules, of which the cumulative power generation amount for a certain time period falls within the certain range, to the number of all solar modules included in the solar array to determine an abnormal solar module.

Specifically, only when the ratio of the number of solar modules, of which the cumulative power generation amount for the certain time period falls within the certain range, to the number of all solar modules included in the solar array exceeds a certain threshold value, a solar module of which the cumulative power generation amount for the certain time period does not fall within the certain range may be determined to be an abnormal solar module.

Through this, the user terminal 100 may prevent an error in which most of the solar modules are determined to be abnormal solar modules when a solar system is not operating properly due to weather conditions or the like.

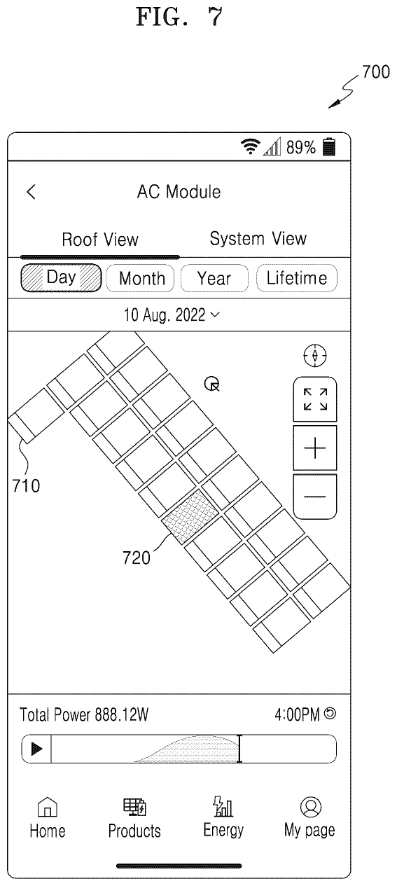

An interface displaying an abnormal solar module and a notification for maintenance are described in detail with reference to FIGS. 7 to 9 below.

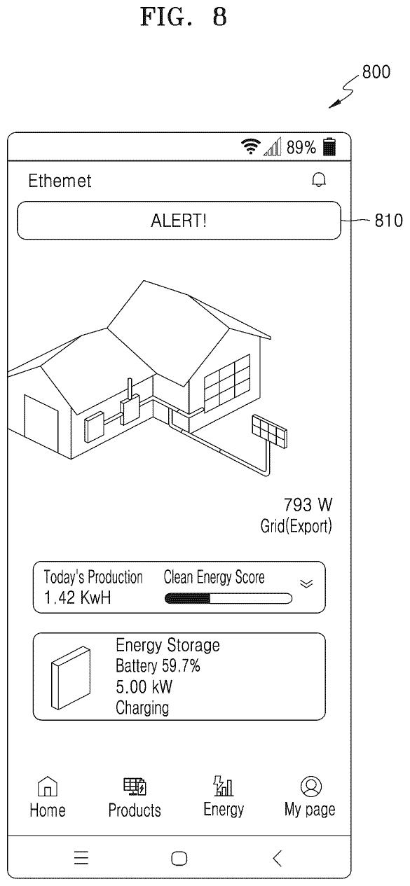

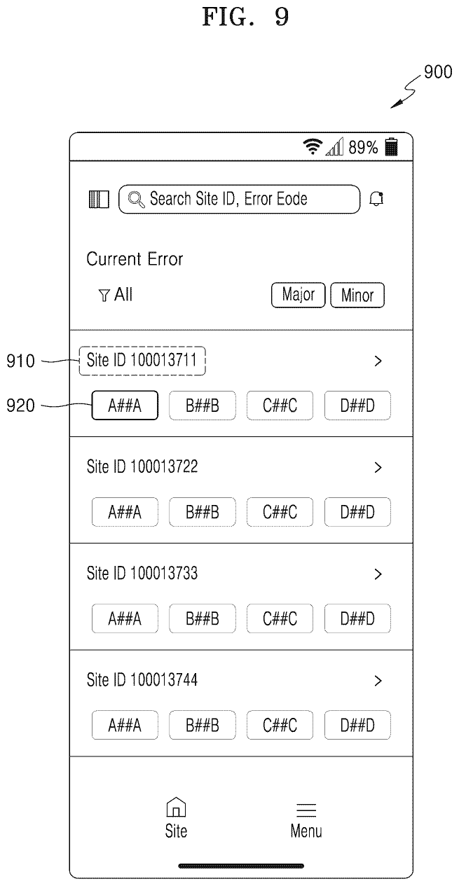

FIG. 7 is a diagram illustrating an interface that displays an abnormal solar module, according to an embodiment. FIG. 8 is a diagram illustrating an interface that displays a notification for maintenance of a solar module, according to an embodiment. FIG. 9 is a diagram illustrating an interface that displays a notification of an error code, according to an embodiment.

Referring to FIG. 7, an interface 700 may be an example interface that displays an abnormal module.

For example, the user terminal 100 may generate an interface displaying all solar modules included in the solar array. The user terminal 100 may generate an interface that displays an abnormal solar module 720 and a normal solar module 710 differently from each other by at least one of hue, saturation, and brightness so that among all solar modules included in the solar array, the abnormal solar module 720 and the normal solar module 710 may be easily distinguished from each other. For example, the user terminal 100 may generate an interface that displays the abnormal solar module 720 and the normal solar module 710 with different hues so that a user may efficiently recognize the location, number, type, etc. of solar modules having a failure through the interface.

Referring to FIG. 8, an interface 800 may be an example interface that displays a notification 810 for maintenance on an abnormal solar module.

For example, when an abnormal solar module occurs, the user terminal 100 may provide a user with the notification 810 for maintenance of the abnormal solar module.

Through this, the user may immediately recognize when the abnormal solar module is found and may prevent trouble with power supply via solar power generation in advance.

Referring to FIG. 9, an interface 900 may be an example interface that displays an error code 920 indicating information about the cause of a failure of an abnormal solar module.

For example, the user terminal 100 may determine the error code 920 indicating information about the cause of a failure of an abnormal solar module. Specifically, the user terminal 100 may analyze the cause of a failure in a solar module determined to be an abnormal solar module and may determine the error code 920. For example, the user terminal 100 may analyze the power generation amount of an abnormal solar module over time and determine the error code 920.

The user terminal 100 may also generate an interface that displays a unique identification (ID) 910 of the abnormal solar module and the error code 920 of the abnormal solar module.

Through this, a user may quickly recognize the cause of a failure of an abnormal solar module and may take measures according to the cause of the failure.

According to the problem solving means of the present disclosure described above, the present disclosure may efficiently detect a solar module having a failure, based on various power data.

In addition, the present disclosure may promptly notify a user when a failure occurs in a solar module, thereby instructing an immediate response to the failure.

In addition, the present disclosure may generate an interface that allows a faulty solar module to be efficiently distinguished from a non-faulty solar module, thereby allowing a user to immediately recognize the faulty solar module.

An embodiment of the present disclosure may be embodied as a computer program that may be executed on a computer using various components. The computer program may be recorded in a computer-readable medium. At this time, the computer-readable medium may include a magnetic medium such as a hard disk, a floppy disk, or magnetic tape, an optical recording medium such as CD-ROM or DVD, a magneto-optical medium such as a floptical disk, or a hardware device, such as ROM, RAM, or flash memory, which is specifically configured to store and execute program instructions.

The computer program may be specially designed and configured for the present disclosure or may be known and available to those skilled in the field of computer software. Examples of the computer program may include machine code created by a compiler and high-level language code that may be executed on a computer using an interpreter.

According to an embodiment, a method according to various embodiments of the present disclosure may be included in a computer program product. The computer program product may be traded between a seller and a buyer as a commodity. The computer program product may be distributed as a machine-readable storage medium (e.g., a CD-ROM) or may be distributed online (e.g., downloading or uploading) via an application store (e.g., Play Store™), or directly between two user devices. In the case of online distribution, at least a portion of the computer program product may be temporarily stored or temporarily created in a machine-readable storage medium, such as memory of a manufacturer's server, an application store's server, or a proxy server.

The operations of the method described herein can be performed in any suitable order unless otherwise indicated herein or otherwise clearly contradicted by context. The present disclosure is not necessarily limited to the described order of the operations. The use of any or all examples or exemplary language (e.g., “such as”) provided herein is intended merely to elaborate the present disclosure and does not pose a limitation on the scope of the present disclosure unless otherwise claimed. Numerous modifications and adaptations will be readily apparent to one of ordinary skill in the art without departing from the spirit and scope of the appended claims or their equivalents.

Therefore, the spirit of the present disclosure should not be limited to the embodiments described above, and the scope of the following claims and the scope of equivalents of the claims or the equivalently modified scope are all included in the spirit of the present disclosure.

What is claimed is:

1. A method of detecting a failure of a solar module, the method comprising:
obtaining real-time power generation data of each of a plurality of solar modules included in at least one solar array;
setting a reference value using at least one of past power generation data of the plurality of solar modules and specifications of the plurality of solar modules;
determining each of the plurality of solar modules to be either a normal solar module or an abnormal solar module by comparing the reference value with a power generation amount of each of the plurality of solar modules, which is calculated using the real-time power generation data; and
providing an interface displaying a solar module determined to be the abnormal solar module.

2. The method of claim 1, wherein
the setting of the reference value includes setting a reference frequency based on at least one load included in a solar power generation system, and
the determining includes determining each of the plurality of solar modules to be either the normal solar module or the abnormal solar module by comparing a power frequency included in the real-time power generation data with the reference frequency.

3. The method of claim 1, wherein
the setting of the reference value includes setting an average power generation amount of the plurality of solar modules as a reference power generation amount by using the past power generation data, and
the determining includes determining each of the plurality of solar modules to be either the normal solar module or the abnormal solar module by comparing the reference power generation amount with a cumulative power generation amount for a certain time period, the cumulative power generation amount being calculated based on the real-time power generation data.

4. The method of claim 1, wherein
the setting of the reference value includes setting a reference power generation amount based on rated power generation data of the plurality of solar modules, and
the determining includes determining each of the plurality of solar modules to be either the normal solar module or the abnormal solar module by comparing the reference power generation amount with a cumulative power generation amount for a certain time period, the cumulative power generation amount being calculated based on the real-time power generation data.

5. The method of claim 1, wherein
the providing of the interface includes providing an interface that displays the normal solar module and the abnormal solar module differently from each other by at least one of hue, saturation, and brightness.

6. The method of claim 1, wherein
the providing of the interface includes providing a notification for maintenance of the abnormal solar module.

7. The method of claim 6, wherein
the providing of the notification includes:
determining an error code indicating information on a cause of a failure of the abnormal solar module; and
providing the notification for the error code.

8. The method of claim 1, wherein
the providing of the interface includes providing the interface additionally displaying power data of all the plurality of solar modules included in the solar array.

9. A computing apparatus comprising:
a memory storing at least one program; and
a processor configured to perform an operation by executing the at least one program,
wherein the processor is further configured to
obtain real-time power generation data of each of a plurality of solar modules included in at least one solar array,
set a reference value using at least one of past power generation data of the plurality of solar modules and specifications of the plurality of solar modules,
determine each of the plurality of solar modules to be either a normal solar module or an abnormal solar module by comparing the reference value with a power generation amount of each of the plurality of solar modules, which is calculated using the real-time power generation data, and
provide an interface displaying a solar module determined to be the abnormal solar module.

10. The computing apparatus of claim 9, wherein
the processor is further configured to
set a reference frequency based on at least one load included in a solar power generation system and
determine each of the plurality of solar modules to be either the normal solar module or the abnormal solar module by comparing a power frequency included in the real-time power generation data with the reference frequency.

11. The computing apparatus of claim 9, wherein
the processor is further configured to
set an average power generation amount of the plurality of solar modules as a reference power generation amount by using the past power generation data and
determine each of the plurality of solar modules to be either the normal solar module or the abnormal solar module by comparing the reference power generation amount with a cumulative power generation amount for a certain time period, the cumulative power generation amount being calculated based on the real-time power generation data.

12. The computing apparatus of claim 9, wherein
the processor is further configured to
set a reference power generation amount based on rated power generation data based on the specifications of the plurality of solar modules and
determine each of the plurality of solar modules to be either the normal solar module or the abnormal solar module by comparing the reference power generation amount with a cumulative power generation amount for a certain time period, the cumulative power generation amount being calculated based on the real-time power generation data.

13. The computing apparatus of claim 9, wherein
the processor is further configured to provide an interface that displays the normal solar module and the abnormal solar module differently from each other by at least one of hue, saturation, and brightness.

14. The computing apparatus of claim 9, wherein
the processor is further configured to additionally provide a notification for maintenance of the abnormal solar module.

15. The computing apparatus of claim 14, wherein
the processor is further configured to determine an error code indicating information on a cause of a failure of the abnormal solar module and provide a notification for the error code.

16. The computing apparatus of claim 9, wherein
the processor is further configured to provide the interface additionally displaying power data of all the plurality of solar modules included in the solar array.

17. A computer-readable recording medium storing a program for executing the method of claim 1.
